(19) United States
(12) Patent Application Publication
(10) Pub. No.: US 2012/0086536 A1
(43) Pub. Date: Apr. 12, 2012

(54) High Frequency Power Transformer and Method of Forming

(76) Inventor: Michael John Harrison, Christchurch (NZ)

(21) Appl. No.: 13/146,174

(22) PCT Filed: Jan. 8, 2010
(86) PCT No.: PCT/NZ10/00003

§ 371 Date: Dec. 22, 2011

(30) Foreign Application Priority Data
Jan. 28, 2009 (NZ) 574515

(51) Int. Cl. H01F 27/34

(52) U.S. Cl. 336/173

(57) ABSTRACT

A high frequency power transformer including a first winding, a second winding and a core, wherein: the core is arranged to encompass at least a portion of the second winding, the second winding includes at least two winding apertures that pass through the second winding, and the first winding is arranged to pass through the at least two winding apertures.

### FIELD OF THE INVENTION

The present invention relates to a high frequency power transformer and a method of forming a high frequency power transformer. In particular, the present invention relates to a high frequency power transformer wherein the first winding is arranged to pass through the at least two winding apertures of a second winding, and a method of forming said transformer.

### BACKGROUND

When forming high frequency power transformers a number of potential problems need to be taken into account in order for the transformer to operate as efficiently and effectively as possible.

A first problem is that caused by the “skin effect”, which is an AC (Alternating Current) phenomena. When AC flows through a conductor, such as a wire or cable, internal eddy currents are created within the conductor. These eddy currents cause the current density to be greater at the surface of the conductor than at the centre of the conductor. This is due to the effective resistance of the conductor increasing with current frequency towards the centre of the conductor.

Referring to FIG. 1A, a cross section along the circumference of a conductor 101 is shown. It is assumed that an AC signal is passing through the conductor 101. Due to the AC signal, the current density 103 is indicated as strongest around the edges of the conductor 101. Referring to FIG. 1B, the same conductor 101 is shown as a cross section along its length to indicate the same current density 103 along the surface of the conductor.

A second problem is that caused by current crowding or the “proximity effect”. This occurs at edges along the conductor where the magnetic field strength (flux) is concentrated. This is particularly relevant in a transformer where a first isolated conductor has an AC signal passing through it to create a magnetic field.

The magnetic field of the first conductor induces eddy currents in an adjacent conductor, which alters the distribution of the current through the adjacent conductor. That is current crowding will occur along the surface of the second conductor adjacent to the first conductor. This effectively increases the AC resistance of the adjacent conductor and so increases heating and losses.

Referring to FIG. 2, an isolated conductor 201 is shown next to an adjacent conductor 203. An alternating current 205 is represented as passing through the isolated conductor 201. This current 205 creates a magnetic field 207, which in turn causes eddy currents to be created within the adjacent conductor 203. The eddy currents cause the current crowding 209 problem associated with the current flowing near the surface of the adjacent conductor 203. That is, the crowding problem is due to current concentration of adjacent regions of windings.

One known method of mitigating these effects is to use Litz wire, which consists of a number of smaller diameter wires that are individually insulated from each other and twisted together. This aids in the reduction of the skin effect and proximity effect to some extent. However, Litz wire is expensive.

The present invention aims to overcome, or at least alleviate, some or all of the afore-mentioned problems, or to at least provide the public with a useful choice.

### SUMMARY OF THE INVENTION

According to one aspect, the present invention provides a high frequency power transformer including a first winding, a second winding and a core, wherein: the core is arranged to encompass at least a portion of the second winding, the second winding includes at least two winding apertures that pass through the second winding, and the first winding is arranged to pass through the at least two winding apertures.

According to a further aspect, the present invention provides a method of forming a high frequency power transformer that includes a first winding, a second winding and a core, the method including the steps of: arranging the core to encompass at least a portion of the second winding, and arranging the first winding to pass through at least two winding apertures of the second winding.

According to particular embodiments of the present invention the problems associated with current crowding and skin effect are reduced.

### BRIEF DESCRIPTION OF THE DRAWINGS

Embodiments of the present invention will now be described, by way of example only, with reference to the accompanying drawings, in which:

FIG. 1A shows the skin effect on a cross sectional portion of a conductor;

FIG. 1B shows the skin effect on a conductor;

FIG. 2 shows the current crowding effect on an adjacent conductor;

FIG. 3 shows a winding of a high frequency power transformer according to an embodiment of the present invention;

FIG. 4 shows a front view of a high frequency power transformer according to an embodiment of the present invention;

FIG. 5A shows a perspective view of windings of a high frequency power transformer according to a further embodiment of the present invention;

FIG. 5B shows a perspective view of a high frequency power transformer according to a further embodiment of the present invention;

FIG. 6 shows a cross sectional view of a winding of a high frequency power transformer according to a further embodiment of the present invention;

FIG. 7A shows a winding of a high frequency power transformer according to a further embodiment of the present invention;

FIG. 7B shows the winding of FIG. 7A after a further manufacturing step;

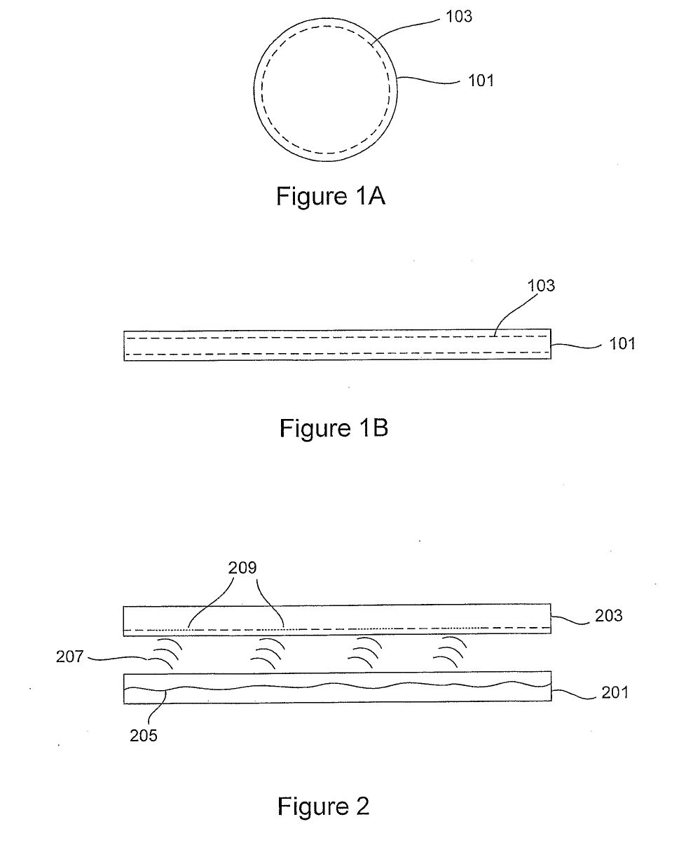

### DETAILED DESCRIPTION OF THE INVENTION

### First Embodiment

A first embodiment of a high frequency power transformer is now described. A high frequency transformer may be used such as used, for example, in a switch mode power supply or converter.

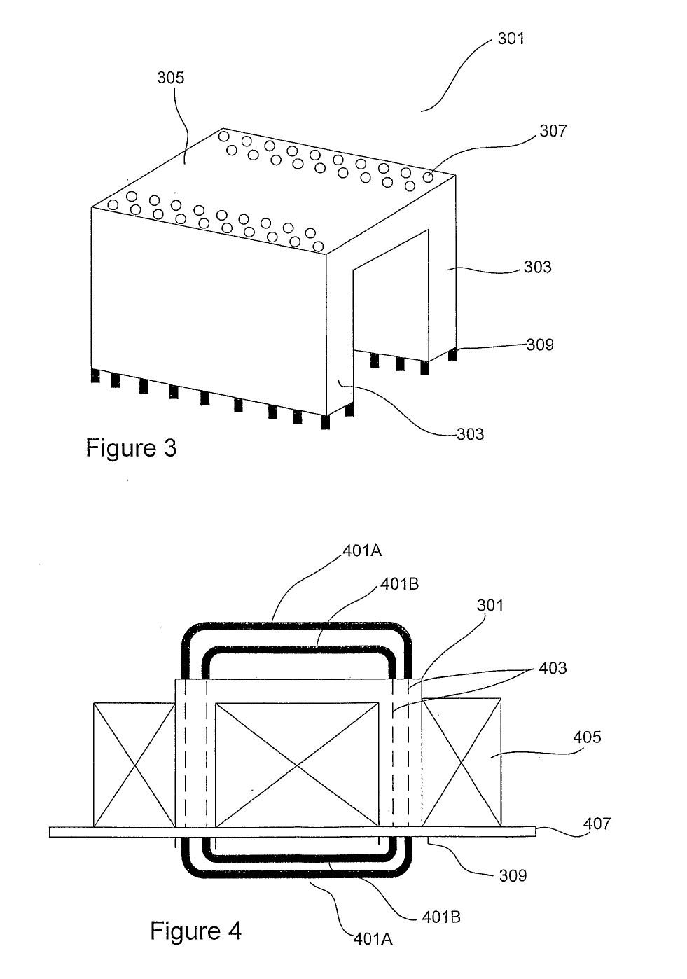

FIG. 3 shows a winding of a high frequency power transformer according to this embodiment.

The winding 301 is formed from an extruded block of copper in this embodiment. However, it will be understood that the winding may also be formed from one or more other suitable electrically conductive materials that are used in forming windings of transformers, such as aluminium for example.

The winding 301 may be formed from a solid block of copper where a portion of the copper is removed from the block using any known suitable techniques, such as milling for example. In this embodiment, the winding is formed into a substantially C or U shaped portion, which includes two side leg portions 303 that are approximately parallel to each other and a top portion 305 that interconnects the side leg portions 303. In this embodiment, the winding 301 is a single unitary piece of copper. That is, the side portions and top portion of the winding are formed as single integral element.

A plurality of holes or apertures 307 are formed through each of the side portions 303 so that they run from the end of each side portion nearest the top portion 305 through to the opposite distal end of the side portion. That is, a matrix of holes (winding apertures) pass through from the top to the bottom of the side portions 303. The holes are formed using any suitable known manufacturing technique, such as drilling for example.

Also formed at the bottom of the side portions (i.e. the distal ends not adjacent the top portion) are a number of pins 309 that are shaped to enable the winding to be attached or soldered into an electrical circuit board such as a printed circuit board (PCB). These contact pins may also be formed using any suitable manufacturing technique, such as milling.

FIG. 4 shows a front view of a high frequency power transformer using the winding 301 as described above with reference to FIG. 3. In this embodiment, the winding 301 is a secondary winding of the transformer. Primary windings (401A & 401B) are formed from solid copper wire. Each copper wire has electrical insulating material formed around the outer circumference of the wire. In this embodiment, the insulating material is provided as a triple layer to ensure there is a re-enforced insulation layer between the primary and secondary windings. It will be understood that, as an alternative, the number of insulating layers may be varied. The insulating material may be any suitable electrical insulation material, such as, for example

The primary windings 401 are passed through channels 403 which are formed by the holes 307 of the secondary winding 301. A ferrite core 405 is provided on the outer surfaces of the side portions, and in the formed aperture within the C-shaped winding block 301. That is, the core includes a first core aperture through which at least a portion of the first side portion of the secondary winding is positioned and a second core aperture through which at least a portion of the second side portion of the secondary winding is positioned.

Termination pins 309 are used to attach the secondary winding of the transformer to the PCB 407 via corresponding holes on the PCB.

Therefore, the primary windings are enclosed or encased within the secondary winding on two of the four sides of the primary winding loop.

By forming the transformer in this manner, the problems associated with the skin effects and current crowding problems of prior known transformers are greatly reduced. This is due to the primary winding being encased or enclosed by the secondary winding. By enclosing or encasing the primary winding within the secondary winding, the sum of the primary winding flux does not cause eddy currents to create current crowding within the secondary winding. Instead, each individual primary winding induces a proportion of the total amount of magnetic flux within the secondary winding portion around a local area formed around the channel through which the primary winding passes. Thus, the current flowing along the periphery of the windings is distributed about the whole periphery and so the current crowding problem is mitigated.

### Further Embodiments

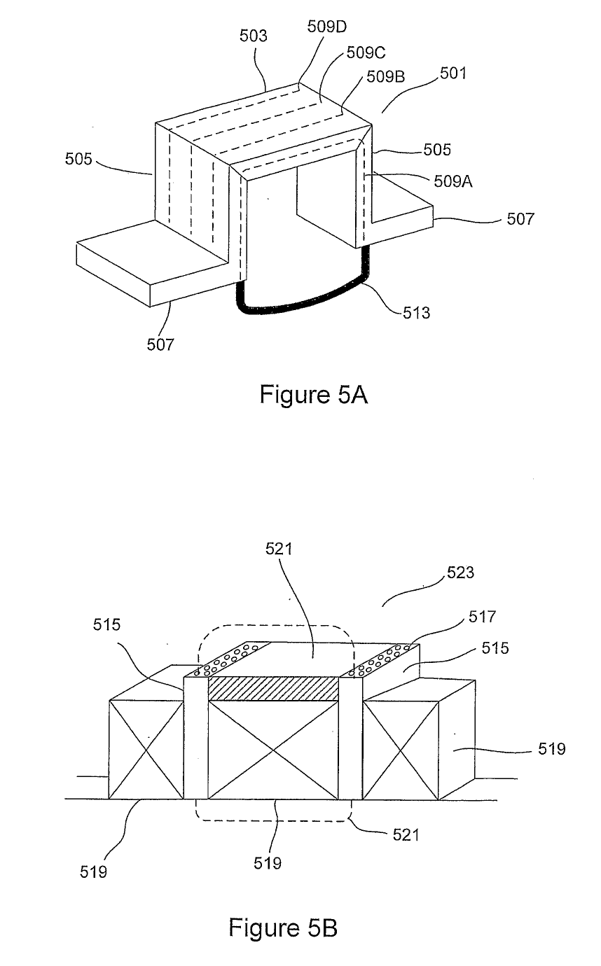

FIG. 5A shows a perspective view of windings of a high frequency power transformer winding 501 according to a further embodiment of the present invention.

In this embodiment, the primary windings of the transformer are enclosed or encased within the secondary winding on three sides of the primary winding loop.

The secondary winding 501 is formed from three different pieces of copper. A first piece of copper forms a top portion 503 of the winding. The copper top portion is substantially rectangular in cross section, with the opposing side edges of the top portion 503 including a chamfered edge. The second and third copper portions include a side portion 505 that is integrally formed with a bottom portion 507 to form a substantially L-shaped portion. The top edge of each side portion 505 is formed with a chamfered edge that corresponds with an adjacent chamfered edge of the top portion 503 when assembled.

Within each of the top portion 503 and the side portions 505 are formed a plurality of channels (509A, 509B, 509C and 509D) that pass longitudinally through each portion. These channels may be formed using any suitable manufacturing technique, such as drilling for example. These channels are used to allow the primary winding 513 to be passed through the secondary winding so it is encased or enclosed within. The primary winding may first be passed through one the channels of one of the side portions during manufacture, and the subsequently through the channels of the top portion and remaining side portion. The top portion 503 may then be placed in position on top of the two side portions 505 to align the channels and form the complete secondary winding 501. That is, the top portion is attached to the side portions after passing the primary windings through the secondary winding channels.

FIG. 5B shows a perspective view of a high frequency power transformer according to a further embodiment of the present invention.

In this embodiment, the form of the transformer is similar to that described in the first embodiment, apart from the secondary winding. The secondary winding in this embodiment is not formed from a single unitary piece of copper, but is instead formed from three separate pieces. Two separate side portions 515 of the secondary winding are formed from rectangular cross sectional pieces of copper. These side portions have holes 517 formed therein using the same techniques as described above. The holes are used to create the channels through which the primary windings (521 & 523) are passed, as described above. A separate solid block of copper have a rectangular cross section is placed on top of the central ferrite core 519 and in between each of the side portions 515.

As the proximity effects are greatest in magnitude between limbs of the core 519 the greatest benefit is achieved within side portions 515 and the windings may be simply wound over end 521 where the proximity effects are much less. This simplifies construction whilst sacrificing little of the benefits.

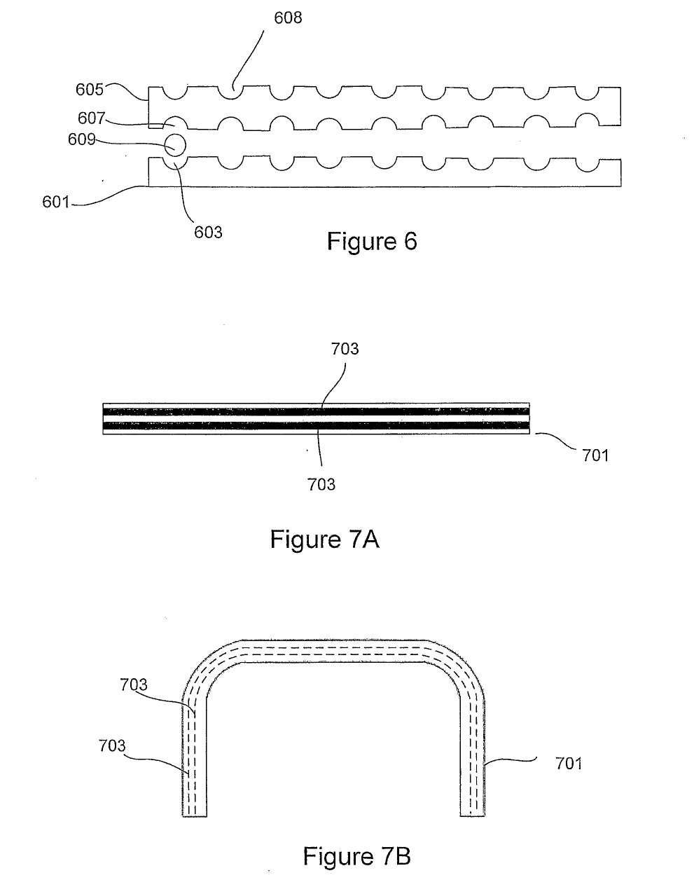

FIG. 6 shows a cross sectional view of a secondary winding of a high frequency power transformer according to a further embodiment of the present invention.

According to this embodiment, the secondary winding is formed from a number of laminate portions. A first laminate portion 601 is formed from copper, preferably by extrusion. The first laminate portion is initially rectangular in cross section and then has a plurality of semi-circular aperture channels 603 formed along one side of its length. That is each aperture is formed to produce an aperture with a cross section of half a circle. A second laminate portion 605 is produced in a similar manner to form corresponding aperture channels 607. Therefore, when the first and second laminate portions 601 & 605 are placed next to each other, a whole circular aperture is formed through which the primary winding can pass. Further channels for the primary winding are formed by providing a number of further semi-circular apertures 608 on the opposing side of the second laminate portion, which will correspond with a further laminate portion placed against the laminate.

This embodiment allows the primary windings to be wound about a laminate layer 601 over the aperture channels 603. Subsequently, the next laminate layer 605 is placed in position for the primary winding to be further wound over the aperture channels 608 of the second laminate layer 605. Subsequently, a further laminate layer 601 closing off the channels may be used, or if further windings are required, a further laminate layer 605 adding more apertures (channels) may be used.

Once the laminate portions are formed they are fixed together using any known suitable laminate fixing technique, such as, for example,

Therefore, multiple channels can be formed within the secondary winding without the requirement to drill through the length of the secondary winding portions. Laminations may be used in the examples shown in FIGS. 3 to 5B.

FIG. 7A shows a winding of a high frequency power transformer according to a further embodiment of the present invention.

The secondary winding 701 shown in FIG. 7A is formed from a single unitary piece of copper. The channels 703 through which the primary winding is to pass are formed within the channel using any suitable technique, such as drilling for example. The winding 701 is then formed into a substantially U-shape by bending the copper, as shown in FIG. 7B. The primary windings are then fed through the channels of the secondary winding to form the complete transformer.

Alternatively, a series of bent laminate layers could be used to form the complete winding and to enable the primary winding to the placed around the secondary winding as the laminate layers are placed together, in a similar manner as described above. That is, the laminate layers are created as shown in and described with reference to FIG. 6, and then subsequently bent to form the secondary winding.

This provides an additional advantage in that edges are removed from the secondary winding so the current flowing through the winding is not subject to current crowding problems at the edge areas.

It will be understood that the embodiments of the present invention described herein are by way of example only, and that various changes and modifications may be made without departing from the scope of invention.

Further, it will be understood that the references to primary and secondary windings may be interchanged.

Further, it will be understood that there may be two or more apertures or channels formed within the winding.

Further, it will be understood that the profile of the top portion, whether an integral portion of the winding or not, may be a linear shaped profile, a curved profile or an irregularly shaped profile.

1. A high frequency power transformer including a first winding, a second winding and a core, wherein:
the core is arranged to encompass at least a portion of the second winding,
the second winding includes a first side portion, a second side portion and a top portion each including at least two winding apertures that pass through the second winding, and
the first winding is arranged to pass through the at least two winding apertures.

2. The transformer of claim 1, wherein the core includes a first and second core aperture into which at least a portion of the second winding is arranged.

3. The transformer of claim 1, wherein the second winding is a secondary winding, and the first winding is a primary winding.

4. The transformer of claim 1, wherein the second winding includes a matrix of winding apertures.

5. The transformer of claim 1, wherein the second winding includes a first side portion, a second side portion and a top portion formed as a single integral element.

6. The transformer of claim 1, wherein the second winding includes a first side portion, a second side portion and a top portion that are separate elements which are joined together to form the second winding.

7. The transformer of claim 6, wherein the first side portion is connected to a first edge of the top portion and the second side portion is connected to a second edge of the top portion, the first edge opposing the second edge.

8. The transformer of claim 6, wherein the first and second side portions are arranged to extend from the top portion in a direction substantially perpendicular to the top portion.

9. The transformer of claim 6, wherein the core includes a first and second core aperture, and the first side portion is at least partially arranged within the first core aperture and the second side portion is at least partially arranged within the second core aperture.

10. The transformer of claim 6, wherein one or more of the winding apertures are formed longitudinally through the first side portion, and one or more winding apertures are formed longitudinally through the second side portion.

11. The transformer of claim 10, wherein one or more of the winding apertures are formed longitudinally through the top portion, such that individual winding apertures in the first and second side portions are aligned with individual winding apertures in the top portion.

12. The transformer of claim 6, wherein the top portion has a curve shaped profile.

13. The transformer of claim 6, wherein the top portion has a linear shaped profile.

14. The transformer of claim 6, wherein the top portion has an irregularly shaped profile.

15. The transformer of claim 1, wherein the second winding includes contact pins for connecting the second winding to an electrical circuit board.

16. The transformer of claim 1, where the first winding includes a solid copper wire with a plurality of insulation layers.

17. The transformer of claim 1, where the second winding is formed from a plurality of laminate portions.

18. The transformer of claim 17 wherein the laminate portions include a plurality of apertures for the first winding to locate in.

19. A method of forming a high frequency power transformer that includes a first winding, a second winding and a core, the method including the steps of:
arranging the core to encompass at least a portion of the second winding, and
arranging the first winding to pass through at least two winding apertures of the second winding along the entire length of the second winding.

20. The method of claim 19, further including the steps of positioning at least a portion of the second winding within a first and second core aperture of the core.

21. The method of claim 19, wherein the second winding is a secondary winding, and the first winding is a primary winding.

22. The method of claim 19, wherein the winding apertures are formed as a matrix of winding apertures.

23. The method of claim 19 further including the step of forming the second winding from a first side portion, a second side portion and a top portion in a single integral element.

24. The method of claim 19 further including the steps of forming the second winding from a first side portion, a second side portion and a top portion from separate elements, and joining the separate elements together to form the second winding.

25. The method of claim 24 further including the steps of connecting the first side portion to a first edge of the top portion and connecting the second side portion to a second edge of the top portion, wherein the first edge is arranged to oppose the second edge.

26. The method of claim 24 further including the step of arranging the first and second side portions to extend from the top portion in a direction substantially perpendicular to the top portion.

27. The method of claim 23, wherein the core includes a first and second core aperture, and the method further includes the steps of arranging the first side portion so it is at least partially arranged within the first core aperture and arranging the second side portion so is at least partially arranged within the second core aperture.

28. The method of claim 23 further including the steps of forming the winding apertures longitudinally through the first side portion and the second side portion.

29. The method of claim 28 further including the steps of forming the winding apertures longitudinally through the top portion, such that individual winding apertures in the first and second side portions are aligned with individual winding apertures in the top portion when assembled.

30. The method of claim 23 further including the steps of forming the top portion to have a curve shaped profile.

31. The method of claim 24 further including the steps of forming the top portion to have a linear shaped profile.

32. The method of claim 24 further including the steps of forming the top portion to have an irregularly shaped profile.

33. The method of claim 19 further including the step of providing a plurality of insulation layers over a solid copper wire to form the first winding.

34. The method of claim 19 further including the step of forming contact pins on the second winding for connecting the second winding to an electrical circuit board.

35. The method of claim 19 further including the step of forming the second winding by assembling a plurality of laminate portions.

36. The method of claim 35 further including the steps of winding a first portion of the first winding around apertures formed on a first laminate portion, and attaching a second laminate portion to the first laminate portion to encase the first portion of the first winding.

37. The method of claim 36 further including the steps of winding a second portion of the first winding within further apertures formed on the second laminate portion, and encasing the second portion of the first winding with a further laminate portion.

38. The method of claim 19 further including the steps of forming the second winding from a single extrusion.

39. The method of claim 38 further including the step of bending the second winding into a U-shape.
